(19) United States
(12) Patent Application Publication
(10) Pub. No.: US 2020/0225650 A1
(43) Pub. Date: Jul. 16, 2020

(54) VEHICLE OR VEHICLE-PART PROTECTIVE SYSTEM FOR MONITORING IMPACTS RECEIVED DURING MANUFACTURE OR ASSEMBLY PROCESS

(71) Applicant: Guillermo Federico TERRONES CASTILLO, Morelos (MX)

(72) Inventor: Guillermo Federico TERRONES CASTILLO, Morelos (MX)

(21) Appl. No.: 16/650,232

(22) PCT Filed: Oct. 1, 2018
(86) PCT No.: PCT/IB2018/057619

§ 371 Date: Mar. 24, 2020

Related U.S. Application Data
(60) Provisional application No. 62/566,973, filed on Oct. 2, 2017.

(51) Int. Cl. G05B 19/418; B62D 65/02; B60J 11/06

(52) U.S. Cl. CPC G05B 19/41875; G05B 19/4183; G05B 2219/45067; B60J 11/06; B62D 65/02

(57) ABSTRACT

A vehicle or vehicle-part protective system, for use in the automotive industry, comprising a plurality of protective panels that attach to the vehicle or vehicle part, these panels serve to protect the vehicle or vehicle part acting as a shield against possible impacts, the protective panels also comprise a plurality of force sensors distributed throughout the panel and thereby, throughout the vehicle or vehicle part to which it is attached. The force sensors are evenly distributed throughout the protective panels and their objective is to detect the occurrence of impacts throughout the surface of the vehicle or vehicle part, during its manufacture or assembly process. The system also provides a digital platform for use in an electronic device, wherein all impacts and information derived from the force sensors distributed throughout the vehicle or vehicle-part can be monitored and alerts provided, in real time. It further provides a graphic interphase for determining the point of the impact within the vehicle or vehicle part.

### CROSS-REFERENCE TO RELATED APPLICATIONS

This application is a national phase entry under 35 U.S.C. § 371 of International Patent Application PCT/IB2018/057619, filed Oct. 1, 2018, designating the United States of America and published in English as International Patent Publication WO 2019/069231 on Apr. 11, 2019 for “Vehicle or Vehicle-Part Protective System for Monitoring Impacts Received During Manufacture or Assembly Process,” which claims priority to U.S. Provisional Patent Application 62/566,973, filed Oct. 2, 2017 for “Vehicle or Vehicle-Part Protective System for Monitoring Impacts Received During Manufacture or Assembly Process,” the disclosure of each of which is hereby incorporated herein in its entirety by this reference.

### TECHNICAL FIELD

This invention relates to a vehicle or vehicle-part protective system for monitoring impacts received during manufacture or assembly process, the system involves a plurality of protective panels that attach to the vehicle or vehicle part, these panels serve to protect the vehicle or vehicle part acting as a shield against possible impacts, the protective panels also comprise a plurality of force sensors distributed throughout the panel.

### BACKGROUND

Impacts to the surface and body of vehicles or vehicle parts is a common and important problem during car manufacture. Car companies can suffer important monetary losses derived from faulty vehicles or vehicle parts that have suffered an impact during manufacture and these could even constitute a security issue.

Solutions to the problem are scarce and normally involve the participation of human factor, which may lead to human error.

The embodiments of present disclosure seeks to solve this problem by mode of an automated system that provides a two-pronged solution: 1) it mechanically protects the vehicle or vehicle part and, 2) it electronically records impacts on the vehicle or vehicle part surface and provides an immediate alert, including several additional data useful in the control and prevention of this type of occurrences.

### SUMMARY

A vehicle or vehicle-part protective system, for use in the automotive industry, comprising a plurality of protective panels that attach to the vehicle or vehicle part, these panels serve to protect the vehicle or vehicle part acting as a shield against possible impacts, the protective panels also comprise a plurality of force sensors distributed throughout the panel and thereby, throughout the vehicle or vehicle part to which it is attached. The force sensors are evenly distributed throughout the protective panels and their objective is to detect the occurrence of impacts throughout the surface of the vehicle or vehicle part, during its manufacture or assembly process. The system also provides a digital platform for use in an electronic device, wherein all impacts and information derived from the force sensors distributed throughout the vehicle or vehicle-part can be monitored and alerts provided, in real time. It further provides a graphic interface for determining the point of the impact within the vehicle or vehicle part.

### BRIEF DESCRIPTION OF THE DRAWINGS

FIG. 1 is a view of an example car containing the protective panels with sensors described in the present specification.

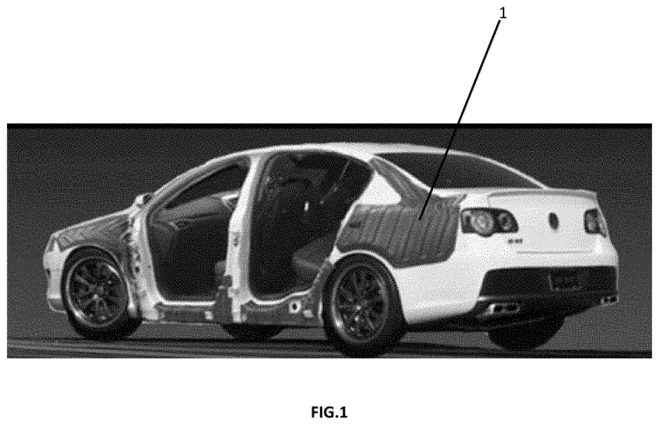

### DETAILED DESCRIPTION

A vehicle or vehicle-part protective system, for use in the automotive industry, comprising a plurality of protective panels (1) that attach to the vehicle or vehicle part, these panels serve to protect the vehicle or vehicle part acting as a shield against possible impacts, each of the protective panels comprises an inside face that contacts the vehicle or vehicle part and an outside face opposite to the vehicle or vehicle part. The protective panels may be divided in one or more impact zones and are adapted to the shape of the car, the protective panels are comprised of a thermoformed sheet on the outside face that serves to transmit more vibrations and cloth on the inside face that does to avoid damage to the car.

Each one of the protective panels comprise one or more embedded force sensors which are attached to the protective panel by magnetic means.

The force sensors are evenly distributed throughout the protective panels and their objective is to detect the occurrence of impacts throughout the surface of the vehicle or vehicle part, during its manufacture or assembly process.

The force sensors, provided in the system, are sensors that can detect the occurrence of impacts and can measure their force.

The force sensors are distributed in all the protective panel and are divided in one or more impact zones. The force sensors detect when an impact occurs, read the voltage and send the information to a computer network.

The force sensors provided in the embodiments of present disclosure are resistant to multiple impacts and exposure to heat.

The force sensors provided in the embodiments of disclosure, are connected between each other as well as to an electronic or digital device that can receive and interpret their collected information.

The vehicle or vehicle-part protecting system further comprises a digital platform that provides a census, derived from the information obtained from the force sensors, that classifies impacts on the vehicle or vehicle-part in three degrees of force: high, medium, low.

The census provides information to capture and monitor possible damages occurred in the production line of vehicles or vehicle-parts.

The system also provides a digital platform for use in an electronic device, wherein all impacts and information derived from the force sensors distributed throughout the vehicle or vehicle-part can be monitored and alerts provided, in real time. It further provides a graphic interface for determining the point of the impact within the vehicle or vehicle part.

The system also provides means for processing information derived from the force sensors to obtain additional data and information derived from the impact in any electronic or digital device.

The present system further provides a control center, which is a computer, mobile device or computer network connected to each force sensor in the protective panels by a wireless computer network the control center has a circuit in charge of receiving the signals and data provided by the force sensors, processing them and sending them to the server and/or a computer application. The control center has a circuit board and a battery or is connected to a power source, to power both the sensors and the circuit.

The vehicle or vehicle-part protective system further comprises a digital platform that can process and register all incidences, derived from the force sensors, related to impacts resulting from the manufacture or assembly process and can filter and show data obtained by the force sensors in the vehicle or vehicle part in an electronic device. For example, some of the data that can be retrieved are: date, time and place of the impact; as well as force and location in the vehicle or vehicle-part. This may be especially useful, for example, for detecting quality control issues and for detecting steps or parts of a manufacture or assembly process where a vehicle or vehicle-part is more prone to being impacted and thereby, damaged; as well as to improve the process and decrease or avoid the incidence of impacts.

The vehicle or vehicle-part protecting system further comprises a digital platform to obtain reports of incidents and exchange these reports among users of the system.

1. A vehicle or vehicle-part protective system for monitoring impacts received during manufacture or assembly process comprising one or more protective panels that attach to the vehicle or vehicle part and are adapted to the shape of the vehicle or vehicle part body, wherein each of the protective panels comprise one or more embedded force sensors connected between each other and connected to an electronic or digital device, the system further comprising a digital platform.

2. The vehicle or vehicle-part protective system for monitoring impacts received during manufacture or assembly process of claim 1, wherein each of the protective panels comprises an inside face that contacts the vehicle or vehicle part and an outside face opposite to the vehicle or vehicle part.

3. The vehicle or vehicle-part protective system for monitoring impacts received during manufacture or assembly process of claim 2, wherein the protective panels are comprised of a thermoformed sheet on the outside face and cloth on the inside face.

4. The vehicle or vehicle-part protective system for monitoring impacts received during manufacture or assembly process of claim 1, wherein the protective panels are divided in one or more impact zones.

5. The vehicle or vehicle-part protective system for monitoring impacts received during manufacture or assembly process of claim 1, wherein the force sensors are attached to the protective panels by magnetic means.

6. The vehicle or vehicle-part protective system for monitoring impacts received during manufacture or assembly process of claim 1, wherein the force sensors provided in the system, are sensors that can detect the occurrence of impacts and can measure their force.

7. The vehicle or vehicle-part protective system for monitoring impacts received during manufacture or assembly process of claim 6, wherein the force sensors are distributed in all the protective panel and are divided in one or more impact zones.

8. The vehicle or vehicle-part protective system for monitoring impacts received during manufacture or assembly process of claim 1, wherein the system comprises a digital platform that provides a census, derived from the information obtained from the force sensors, that classifies impacts on the vehicle or vehicle-part in three degrees of force: high, medium, low.

9. The vehicle or vehicle-part protective system for monitoring impacts received during manufacture or assembly process of claim 8, wherein the digital platform is for use in an electronic device, wherein all impacts and information derived from the force sensors distributed throughout the vehicle or vehicle-part can be monitored and alerts provided, in real time.

10. The vehicle or vehicle-part protective system for monitoring impacts received during manufacture or assembly process of claim 9, wherein the digital platform further provides a graphic interface for determining the point of the impact within the vehicle or vehicle part.

11. The vehicle or vehicle-part protective system for monitoring impacts received during manufacture or assembly process of claim 8, comprising a control center, which is a computer, mobile device or computer network connected to each force sensor in the protective panels by a wireless computer network the control center has a circuit in charge of receiving the signals and data provided by the force sensors, processing them and sending them to the server and/or a computer application. The control center has a circuit board and a battery or is connected to a power source, to power both the sensors and the circuit.
